(19) United States
(12) Patent Application Publication
(10) Pub. No.: US 2007/0165024 A1
(43) Pub. Date: Jul. 19, 2007

(54) Section writing method for volumetric 3D displays

(76) Inventor: Che-Chih Tsao, Arlington, MA (US)

Correspondence Address: CHE-CHIH TSAO, 16 Walnut St., #43, Arlington, MA, 02476, US

(21) Appl. No.: 11/654,887

(22) Filed: Jan. 18, 2007

Related U.S. Application Data
(60) Provisional application No. 60/760,338, filed on Jan. 19, 2006.

(51) Int. Cl. G06T 17/00

(52) U.S. Cl. 345/420

(57) ABSTRACT

This invention describes a data writing method for improving resolution of volumetric 3D display based on a rotating display screen or a rotating display panel. The method separates the active display area of an SLM (or a rotating display panel) into a number of sections. When displayed, each section corresponds to a different volumetric zone in the display space. The display space thereby has a number of zones. The portion of a volumetric 3D image within each zone will therefore be formed by images frames projected from a corresponding section. The image frames from a section is thereby called section frames. The locations of zones are arranged according to their distances with respect to the axis of rotation of the display plane. Inner zones are closer to the axis and outer zones are farther away from the axis. The method writes data to the sections one section at a time in a repetitive and periodical sequence. The images in the sections are displayed in a corresponding sequence, which is also repetitive and periodical. The writing sequence writes more often to the outer sections and less often to the inner sections. Therefore, more section frames are distributed to the outer zones and less section frames are distributed to inner zones. As a result, the distance between adjacent section frames can be maintained roughly even in the display space, regardless of the distance to the axis of rotation of the display plane.

### CROSS-REFERENCE TO RELATED APPLICATIONS AND OTHER DOCUMENTS

This application claims the benefit of prior U.S. provisional application No. 60/760,338 filed Jan. 19, 2006, the contents of which are incorporated herein by reference.

This invention relates to Tsao U.S. patent application Ser. No. 11/183,358 (which claims domestic priority of provisional application 60/589,108 filed on Jul. 19, 2004).

This invention also relates to the following co-pending U.S. applications by Tsao:

application Ser. No. 11/156,792 (claiming domestic priority of provisional application No. 60/581,422 filed Jun. 21, 2004), application Ser. No. 11/185,405 (claiming domestic priority of provisional application No. 60/589,626 filed Jul. 21, 2004), application Ser. Nos. 11/188,408 and 11/188,409 (both claiming domestic priority of provisional application No. 60/591,128 filed Jul. 26, 2004).

This invention also relates to the following US patents by Tsao: U.S. Pat. No. 5,754,147, U.S. Pat. No. 5,954,414, U.S. Pat. No. 6,302,542 B1, U.S. Pat. No. 6,765,566 B1, and U.S. Pat. No. 6,961,045 B2.

The above documents are therefore incorporated herein for this invention by reference.

### STATEMENT REGARDING FEDERALLY SPONSORED R&D

Not Applicable

### REFERENCE TO COMPACT DISK APPENDIX

Not Applicable

### BACKGROUND OF THE INVENTION

This invention relates in general to the field of three-dimensional (3D) volumetric displays. More specifically, it relates to data writing schemes to increase resolution of volumetric 3D displays based on a rotating display screen or a rotating display panel.

One category of volumetric 3D (V3D) displays generates V3D images by moving a screen to sweep a volume and projecting 2D profile images on the screen. V3D images thus form in the swept volume by after-mage effect. The screen motion can in general be rotating or reciprocating. A mechanism of rotational nature is generally applied to drive the motion.

For rotating screen approaches, the screen generally rotates about an axis parallel to and passing through the screen surface. Tsao U.S. Pat. No. 6,765,566 B1, which is incorporated herein by reference, describes an example. FIG. 10 illustrates a V3D display based on a rotating screen with an optical interfacing unit. It has three major portions: a rotating screen unit 1330; a high frame rate image projection system 1310; and a optical interfacing mechanism 1320, which relays the optical image projected from the image projector onto the screen for displaying, while keeping the size, orientation and focus of the projected image invariant as the screen rotates. The preferred optical interfacing mechanism is an optical image rotator rotating at half the speed of the screen. FIG. 11 illustrates an example of an optical rotator as the optical interfacing unit. The screen unit comprises a screen 1331, a central reflector 1332 and a side reflector 1333, which all rotate in unison about a common axis 1000. The projection path is from the projector 1310 to the interfacing unit 1320, then to the central reflector and then to the side reflector and then to the screen. Additional descriptions of this type of V3D display can found in Tsao et al., U.S. Pat. No. 5,754,147, 1998; Tsao, U.S. Pat. No. 5,954,414, 1999 and Tsao, U.S. Pat. No. 5,302,542 B1, 2001, which are incorporated herein by reference.

Another category uses a moving display panel. The moving display panel distributes frames of 2D images in space to form volumetric 3D images by after-image effect. For example, Berlin U.S. Pat. No. 4,160,973 describes a system with a rotating LED panel, which sweeps a cylindrical display volume. For another example, Tsao Japanese patent application publication no. P2002-268136A (FIG. 11) describes a system with a “rotary reciprocating” display panel. The flat panel display rotates about an axis but with its surface always facing a fixed direction. As a result, the display panel sweeps a display space as if in a reciprocating motion.

Still another category uses a volume of material having the property of “step-wise excitation of fluorescence” (or commonly called “2-stage excitation”). Examples include Korevaar U.S. Pat. No. 4,881,068 and Downing et al., Science, 30 Aug. 1996, vol. 273, p. 1185.

In the above example of V3D display, the preferred image source for the projector is a spatial light modulator (SLM) such as DMD (Digital Micro-mirror Device) or FLCD (Ferroelectric Liquid Crystal Display). These are devices of black and white pixels. Using a single DMD or FLCD with a white or monochrome light results in a monochrome volumetric 3D display. To create colors, one can use three DMDs or FLCDs, each illuminated by light of a different primary color. Alternatively, Tsao U.S. patent application Ser. No. 09/882,826 describes a method of using a single panel to generate colors. The single panel is divided into three sub-panels and each sub-panel is illuminated by light of a different primary color. The images of the three sub-panels are then recombined into one at projection. (See FIG. 10a of that application as example.)

In general, the resolution of an SLM-based V3D display in the direction of screen motion is limited by the frame rate of the SLM.

However, a “Sub-frame Method” can be applied to redistribute the pixels on the SLM in the direction of screen motion and to increase the effective frame rate of the SLM. Tsao U.S. Pat. No. 6,765,566 describes the method. The method first separates each color image frame from a projector into three sub-frames in the time domain, each sub-frame of a different primary color, by modulating and switching the color of the illumination source with a color switching means or switching after the projection lens. In the case when the sub-frames are from an SLM defined with sub-panels, this separation is achieved by modulating the illumination to each sub-panel such that only one sub-panel is illuminated at any time and for only a short period of time, as described in Tsao U.S. Pat. No. 6,961,045. Then projected images from three such projectors are superimposed in a manner such that at any moment a superimposed image frames contains 3 sub-frames, each from a different projector and of a different primary color. This allows the display of color V3D images of resolution higher than allowed if only full frames, instead of sub-frames, are used. Further, Tsao U.S. patent application Ser. No. 11/183,358 describes a “sub-frame method” that increases the effective frame rate of a projector based on 3 SLMs by about 3× (FIG. 4 and FIG. 5 of the referred document) without the need of light source modulation or output color switching.

In general, frame by frame projection distributes frames along the path of screen motion and each frame, or sub-frame, cuts across the resulted display space. When the path of screen motion is curved, such as in the case of a rotating screen, the frame distribution gives higher resolution in the central region of the display space than the outer region. It will also be nice if this frame distribution structure can be improved.

### BRIEF SUMMARY OF THE INVENTION

This invention describes a data writing method for improving resolution of volumetric 3D displays based on a rotating display plane. In general, the method increases the resolution in the direction of the motion of the display plane and makes the distribution of frame divisions more evenly. The method generally applies to volumetric 3D displays based on projection of images displayed by one or more SLMs (spatial light modulators). The method also applies to volumetric 3D displays applying a rotating active display, such as an LED or OLED display panel.

The method separates the active display area of an SLM (or a rotating display panel) into a number of sections. When displayed, each section corresponds to a different volumetric zone in the display space. The display space thereby has a number of zones. The portion of a volumetric 3D image within each zone will therefore be formed by images frames projected from a corresponding section The image frames from a section is thereby called section frames. The locations of zones are arranged according to their distances with respect to the axis of rotation of the display plane. Inner zones are closer to the axis and outer zones are farther away from the axis. The method writes data to the sections one section at a time in a repetitive and periodical sequence. The images in the sections are displayed in a corresponding sequence, which is also repetitive and periodical. The writing sequence writes more often to the outer sections and less often to the inner sections. Therefore, more section frames are distributed to the outer zones and less section frames are distributed to inner zones. As a result, the distance between adjacent section frames can be maintained roughly even in the display space, regardless of the distance to the axis of rotation of the display plane.

### BRIEF DESCRIPTION OF THE DRAWINGS

FIG. 10 illustrates a volumetric 3D display based on a rotating screen with an optical interfacing unit in the prior arts.

FIG. 11 illustrates an example of optical interfacing unit in the prior arts.

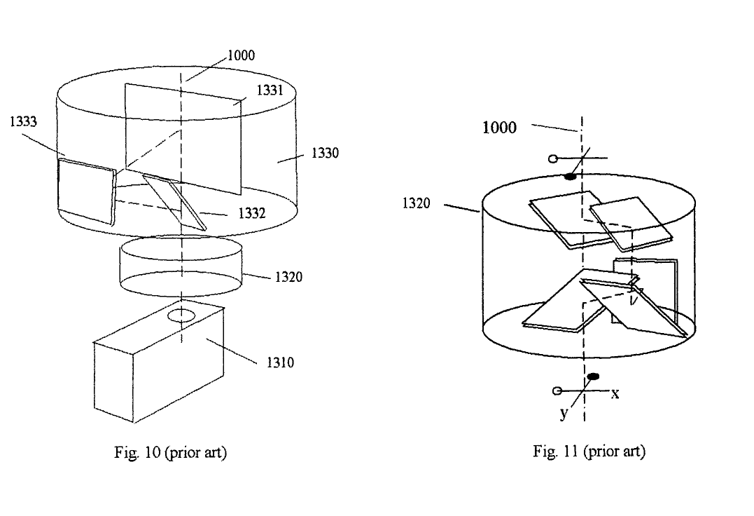

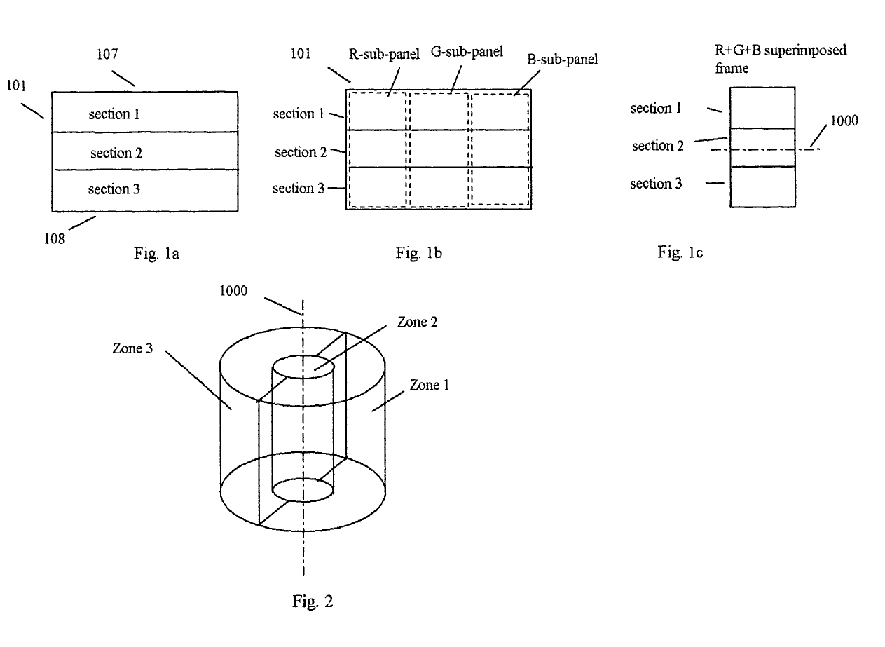

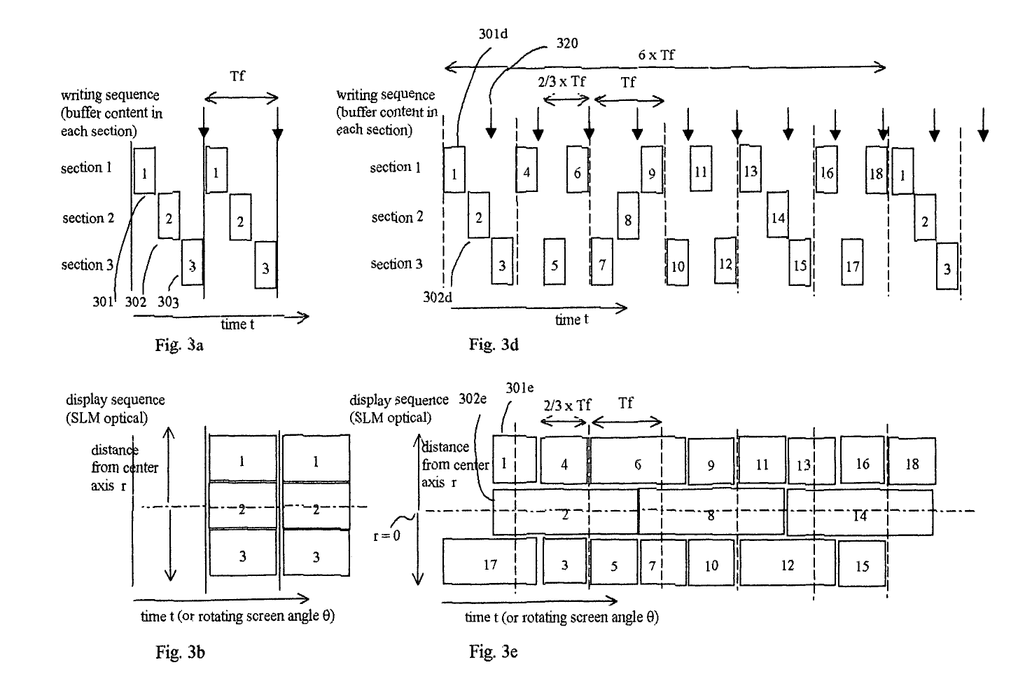

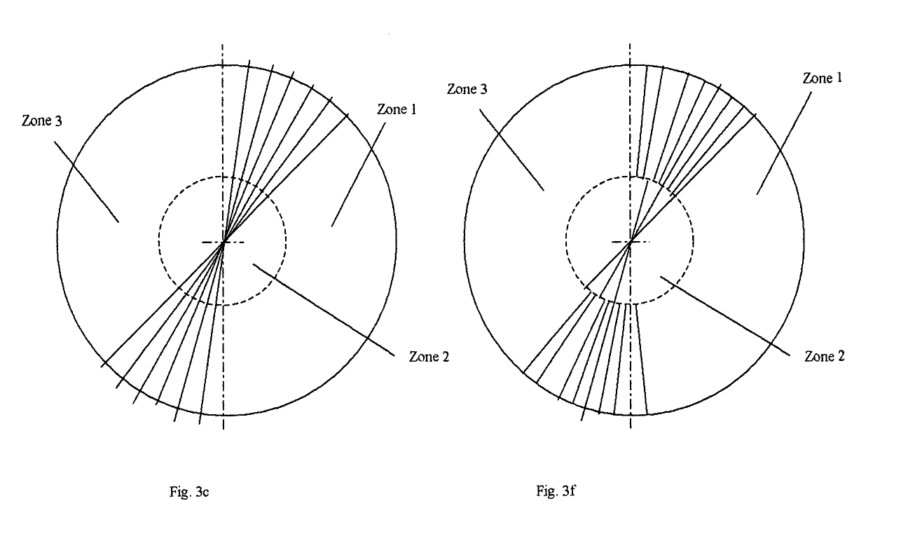

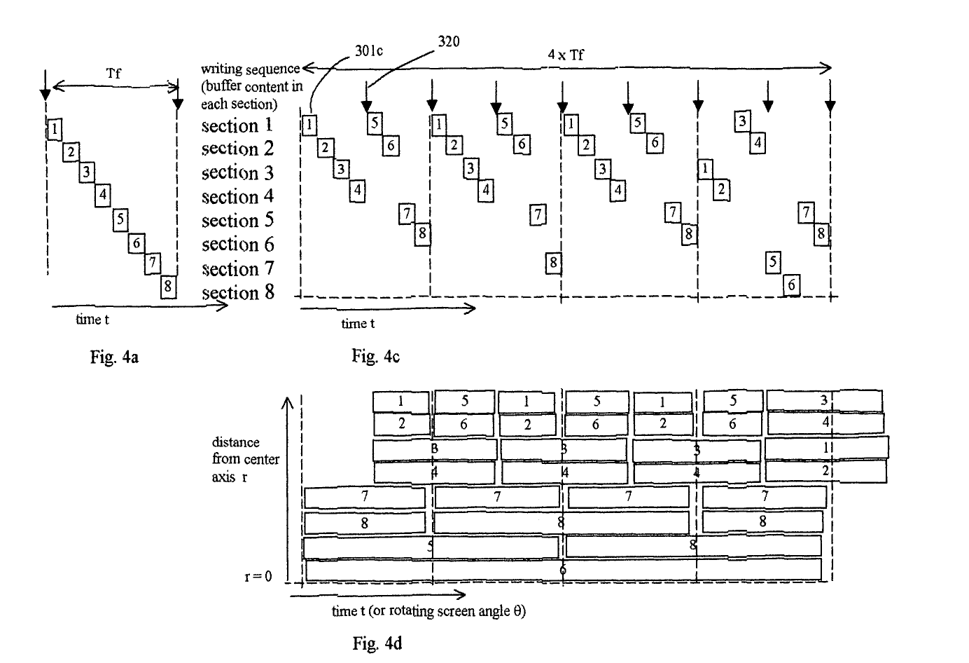

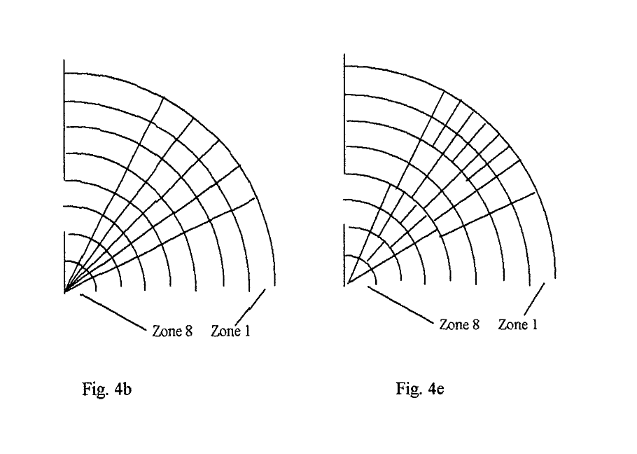

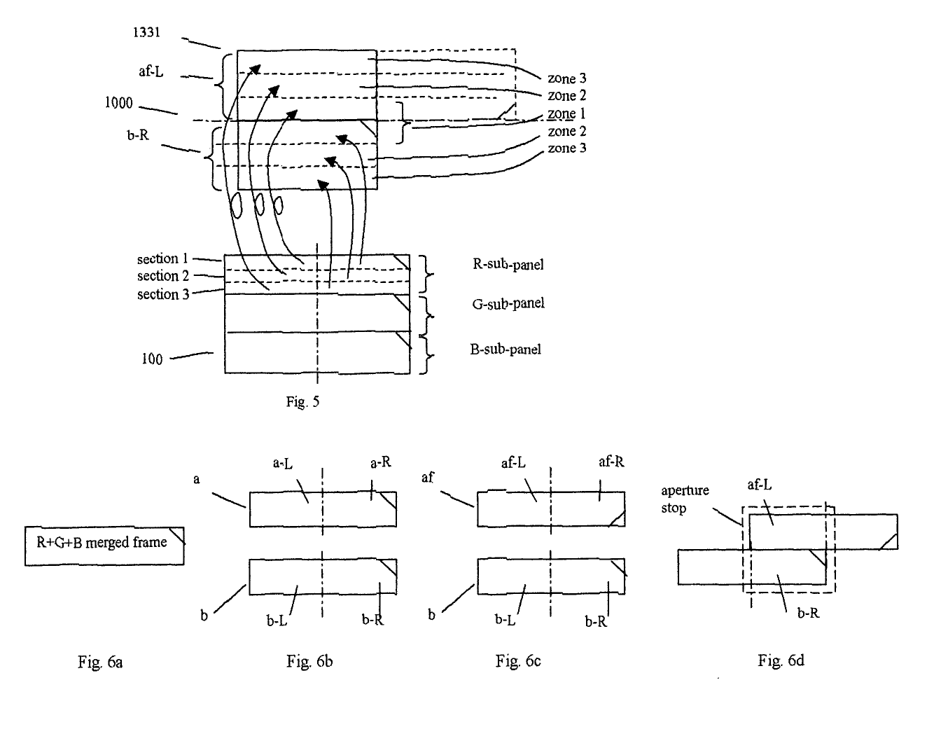

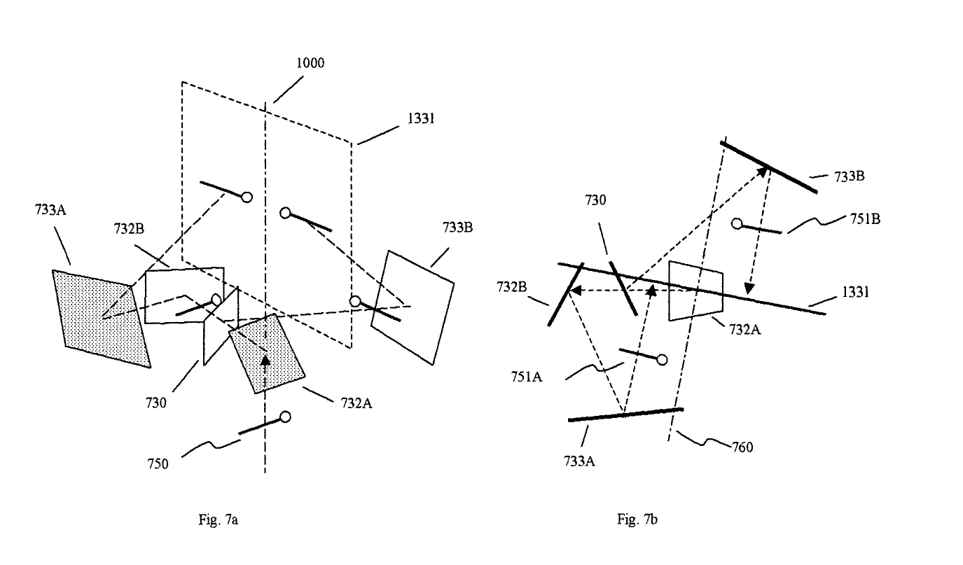

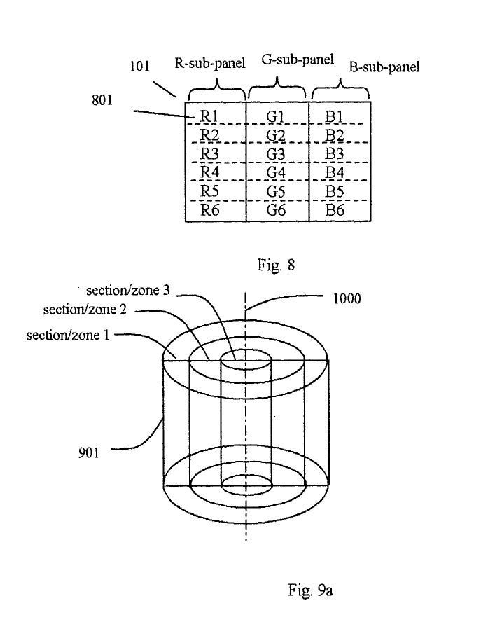

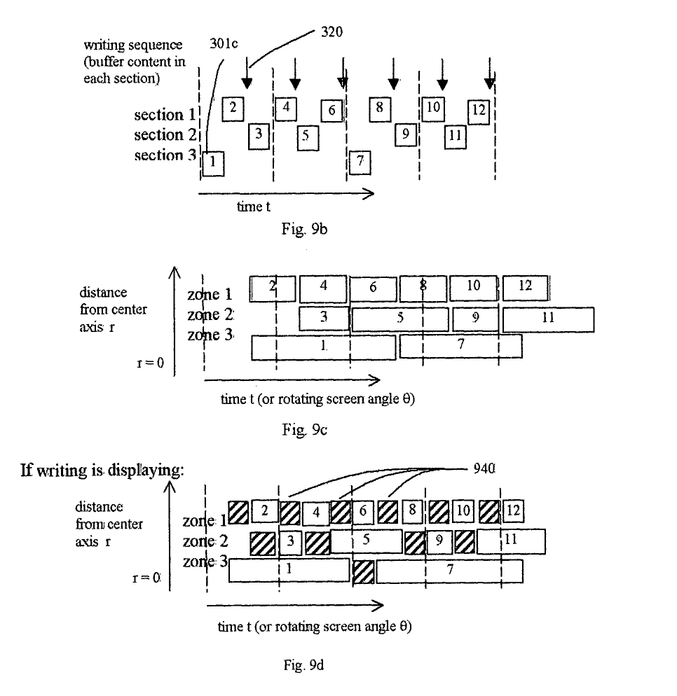

FIGS. 1a-c illustrates a first example of arrangement of sections on a single SLM panel according to this invention.

FIG. 2 illustrates the arrangement of display zones in the display volume according to section arrangement by FIG. 1.

FIGS. 3a-c illustrates a first example of a “regular” data writing sequence, the corresponding image display sequence and the resulted frame distribution structure in the prior arts.

FIGS. 3d-f illustrates a first example of a preferred data writing sequence, its corresponding image display sequence and the resulted frame distribution structure with improved resolution according to this invention.

FIGS. 4a-b illustrates a second example of a “regular” data writing sequence and the resulted frame distribution structure.

FIGS. 4c-e illustrates a second example of a preferred data writing sequence, its corresponding image display sequence and the resulted frame distribution structure with improved resolution according to this invention.

FIG. 5 illustrates a second example of arrangement of sections on a single SLM panel and the mapping between sections and display zones according to this invention.

FIGS. 6a-d illustrates a method of modifying the aspect ratio of a projected sub-frame.

FIGS. 7a-b illustrates an example of optical setup for the modification method of FIGS. 6a-d.

FIG. 8 illustrates a third example of arrangement of sections on a single SLM panel according to this invention.

FIGS. 9a-d illustrates an example of arrangement of sections on a moving display panel according to this invention, also showing the effect of a separate display command.

### DETAILED DESCRIPTION OF THE INVENTION

This invention describes procedures of data writing to improve resolution of V3D displays, especially those based on a rotating display plane.

Tsao U.S. patent application Ser. No. 11/183,358 (which claims domestic priority of provisional application 60/589,108 filed on Jul. 19, 2004) describes a data writing method that can be applied to SLMs with certain functional features. When the active area of the SLM is divided into several sections, this data writing method has the ability to write to and to display individual section one at a time while keeping other sections blank. This allows the separation of images of different sections in the time domain without the need of illumination modulation at the light source or color switching at the optical output end.

By applying the same principle of this data writing method to this current invention, the frame distribution structure in a rotating screen type V3D display can be improved. In general, the method in this invention include the following steps:

(1) Divide the pixels of the SLM into a number of groups and define each group as a section. When projected onto the moving screen, each section forms a volumetric zone in the display space. The display space thereby has a number of zones, each corresponding to a section of the SLM. The portion of a volumetric 3D image within each zone will therefore be formed by images frames projected from a corresponding section. The image frames from a section is thereby called section frames.

(2) Determine a sequence of data writing to sections and determine the locations of section frames in each zone. The limiting condition is that data writing can not be made to two or more different sections at the same time. The goal is to distribute frame sections in the display space as uniform as possible, since the locations of frame sections determine the resolution along the direction of screen motion.

(3) Compute data of each section frame to be displayed in each zone by slicing the 3D image to be displayed according to the structure of section frames determined from step (2).

(4) Write data to each section according to the sequence of data writing from step (2) and display the section frame images according to the locations of section frames.

In the display volume formed by a rotating screen, the inner cylindrical space can be defined as inner zones, which can have less section frames because it is closer to the center axis. The outer tubular space can be defined as outer zones, which need more section frames to improve the resolution. Because of the use of the image delivery mechanism (i.e. optical interfacing unit 1320), the orientation of the projected image frame with respect to the screen does not change as the screen rotates. As a result inner zones can be mapped to inner sections, and outer zones to outer sections, of the SLM. Without the image delivery mechanism, the projected image frame will rotate with respect to the screen when the screen rotates, which makes the mapping of sections to zones impossible.

For example, FIG. 1a illustrates a SLM 101 having three sections defined. The sections are defined in separate and isolated regions on the SLM. In order to display colors, R, G and B “sub-panels” are defined as FIG. 1b. By methods described in Tsao U.S. Pat. No. 6,961,045, the images of the three sub-panels can be recombined and superimposed optically. As a result, the superimposed frame has a different aspect ratio and contains images from the three sections. FIG. 1c illustrates the superimposed image. When the superimposed image is projected to the rotating screen 1331, each section forms one zone. As shown in FIG. 2, central zone 2 corresponds to the central section 2. Zone 1 and 3 correspond to section 1 and 3 respectively.

Assuming a SLM with frame buffer is used. The SLM also uses a separate “display” command to display data retained in the frame buffer. FIG. 3a illustrates the content of the frame buffer with respect to time in a “regular” writing sequence. That is, sections 1-2-3, as shown 301-302-303, are written in sequence repeatedly. FIG. 3b illustrates the resulted optical output, i.e. the display sequence. The time duration of each section frame is uniform, Tf. FIG. 3c illustrates the resulted frame structure (top view of the display volume). The spatial “thickness” of each frame is quite non-uniform in different zones.

FIGS. 3d-f illustrates a first example of a preferred data writing sequence, its corresponding image display sequence and the resulted frame distribution structure with improved resolution according to this invention. FIG. 3d illustrates a preferred data writing sequence. In general, we write the central section (section 2) less often than we write the outer sections. The boxes, e.g. 301d and 302d, indicate data writing. The numbers inside the boxes indicate orders of writing. The vertical arrows, e.g. 320, indicate “display command”. The whole sequence has a period of 6Tf. FIG. 3e illustrates the resulted optical output, i.e. the display sequence. The numbers inside the boxes indicate the corresponding number of writing orders from FIG. 3d. For example, section 1 and section 2 are first written, as shown by 301d and 302d. Then a display command 320 is issued. Accordingly, the images of section 1 and section 2 start to display at the same time, as shown by 301e and 302e. But because section 2 is written less often, one image of section 2 lasts longer than an image of section 1. FIG. 3f illustrated the resulted frame structure. In general, the total number of frames in zone 2 is reduced by a factor of ½×. The total number of frames in the outer zones is increased by a factor of 1.5× The “thickness” of the frames is now more uniform than FIG. 3c.

In order for the preferred writing sequence of FIG. 3d to work, the SLM has to allow data writing to the sections in the preferred order. In general, if each section in the SLM can be accessed, i.e. written to, randomly, then it is the most preferred. However, that level of flexibility is not always needed. In order to achieve the writing sequence of FIG. 3d, the SLM only needs to allow:

(1) Writing in two directions: That is, data can be written in from the top of the SLM down or can be written in from the bottom of the SLM up. Thus both writing sequences of sections 1-2-3 and 3-2-1 can be performed.

(2) Stopping writing at end of any section and then starting writing from top 107 or bottom 108 of the SLM 101: That is, writing in sequences of sections 1-3 or 3-1 as required in FIG. 3d.

A typical example of SLM that has these functions is Texas Instruments Discovery 1100 DMD system, which is commercially available. It also has a frame buffer and uses a separate display command. Tsao U.S. patent application Ser. No. 11/183,358 describes a detailed example of operation and commands of this device.

FIGS. 4a-e shows another example. Assuming the SLM is divided into 16 sections. The structure of the sections and zones is symmetric. Therefore only 8 sections are depicted in the drawings. The display volume therefore has 8 concentric zones.

FIG. 4a illustrates a “regular” writing sequence. The regular frame duration is Tf. FIG. 4b illustrates the resulted frame structure (top view of the display volume) in a time period of 4Tf.

FIG. 4c illustrates one preferred writing sequence by this invention. The numbers inside the boxes indicate orders of writing. Again, we write the outer sections more often than the inner sections. FIG. 4d illustrates the resulted optical output, i.e. display sequence. Again, the numbers inside the boxes indicate the corresponding number of writing orders from FIG. 4d. FIG. 4e illustrated the resulted frame structure. The “thickness” of the frames in FIG. 4e is more uniform. The total number of frames in the outer zones is almost doubled. In this example, the color sub-panel structure can be similar to that of FIG. 1b. That is, this is a single SLM color projector system.

In this example, it is still assumed that the SLM has a frame buffer and uses a separate display command to display images. But in order for the preferred writing sequence of FIG. 4c to work, the SLM has to allow data writing to the sections in the preferred order. This nearly requires the capacity of writing to sections in any random order. In practice, one typical example of such a SLM is Texas Instruments Discovery 3000 DMD system, which is in the state of engineering prototype at the time of this application. It actually allows data writing to any row randomly.

In general, the above examples apply to a projector system of a single SLM. To generate colors, one SLM can use three color sub-panels. Alternatively, we can use three SLMs, each illuminated by a different primary color.

When 3 SLMs are used in a projector (or three single-SLM projectors are used), a “sub-frame method” can be applied to increase the effective frame rate by about three times. As describe previously, Tsao U.S. Pat. Nos. 6,765,566 and 6,961,045 describe sub-frame methods based on illumination modulation at light source or based on color switching of projection output.

Alternatively, Tsao U.S. patent application Ser. No. 11/183,358 describes a “sub-frame method” that does not need source modulation or external color switching devices. In this later approach, the SLM is used to directly modulate the optical output to generate sub-frames. Therefore, by this later approach, the sections defined in this invention must be defined within a color sub-panel. FIG. 5 illustrates an example for this situation. R, G and B sub-panels are defined as separate and isolated regions on the SLM. Within each sub-panel, sections are further defined. In this example, in order for the section writing schemes to work, the SLM must allow writing to sections in any random order. A SLM that allows data writing to any row randomly, as the Discovery 3000 system of Texas Instruments can be used. One practical issue of using such a system is that data must be written into the SLM row by row, so that sub-panels have to be defined with their long-side along the long side of the full panel, as shown in FIG. 5. As a result the merged or superimposed sub-frame can have a very high aspect ratio, as shown in FIG. 6a. This can be non-desirable.

The solution is to cut the merged sub-frame into two halves and then stitch them side by side to change the aspect ratio. This can be done by first split the image of a merged sub-frame into two images a and b, as shown in FIG. 6b. One of the two images is then flipped, as af in FIG. 6c. The two images, af and b, are then be re-aligned side by side to form the new stitched frame (af-L plus b-R, for example), as shown in FIG. 6d. An aperture stop is used to block out the un-wanted halves of the sub-frames. FIG. 5 illustrates how sections are mapped to the stitched frame (and to the zones). Because one of the images is flipped, we are able to stitch section 1 together to form the inner zone (zone 1). By the same reason, section 2 forms zone 2 and section 3 forms zone 3. The content of the sub-panels should of course be programmed to reflect this geometric definition accordingly.

FIG. 7a (perspective view) and FIG. 7b (top view) illustrate the preferred optical setup. 750 is a marker for indicating image orientation. The center reflector 732A receives the projected image frame from the interfacing unit 1320 and sends it to beam splitting reflector 730. The beam splitting reflector splits the projection path into two. The transmitting path is from 730 to reflectors 732B, 733A and to the left part of the translucent screen 1331. The reflecting path is from 730 to reflector 733B to the right part of the screen. Because the two paths reach the screen from opposite sides, one of the two images appears flipped when viewed from one side.

If random data writing to the SLM can be down to the word level, i.e. units smaller than a row, then aspect ratio is not a limiting factor. We can designate R, G and B sub-panels as we wish, and in each sub-panel we can define sections as needed. FIG. 8 illustrates an example. The SLM is defined to have three color sub-panels: R, G and B. Each sub-panel has 6 sections. For example, R sub-panel has R1, R2 . . . R6 sections. Data can be written to any of the 24 sections randomly.

Although a SLM especially a DMD, is used to describe this invention in previous examples, this invention is not limited to volumetric 3D displays using SLMs. The method of data writing also apply to volumetric 3D displays using a moving display panel, such as LEDs (light emitting diodes) or OLED (organic LED display). In this case, sections on the moving display map to zones directly.

In addition, although a frame buffer with a separate display command is assumed in the previous examples, it is not a necessary condition. FIGS. 9a-d illustrates an example of arrangement of sections on a moving display panel according to this invention, also showing the effect of a separate display command. The display panel 901 is separated into 6 sections. The display volume therefore has 6 concentric zones, as shown in FIG. 9a. The structure of the sections and zones is symmetric. Therefore only 3 sections are depicted in the drawings. FIG. 9b illustrates the preferred data writing sequence by this invention. If the display panel has a frame buffer and a separate display command exists, then the display sequence looks like FIG. 9c. This is basically similar to previous examples. However, if the display panel does not have a separate display command and data are displayed once they are written, then the display sequence looks like FIG. 9d. The main differences are: (1) the timing of each section frame is slightly different from that of FIG. 9c; and (2) there is a longer transition period 940 between two successive section frames, which reflects the time required to over-write a section with the next section frame. But we still get more frame divisions in the outer zone than in the inner zone.

1. Method for providing a generally uniform frame distribution structure for a volumetric 3D display, said volumetric 3D display comprising a rotating display plane, said display plane rotating around an axis and sweeping a display volume, said display plane comprising a display panel or a media with images projected from a spatial light modulator, said method including the steps of:
(1) dividing the display volume into a number of zones according to distance to said axis, zones closer to said axis being inner zones, zones farther away from said axis being outer zones;
(2) defining on the display area of said display panel or said spatial light modulator a number of sections, each said section corresponding to one of said zones respectively, sections corresponding to inner zones being inner sections and sections corresponding to outer zones being outer sections;
(3) writing image data to be displayed to said sections one section at a time in a repetitive and periodical writing sequence, said writing sequence writing more often to said outer sections and less often to said inner sections;
(4) concurrently with step (3), displaying images of said sections in a display sequence corresponding to said writing sequence.

2. Method of claim 1,
said display volume being divided into 3 zones, and said display panel or spatial light modulator being defined with 3 sections;
said display panel or spatial light modulator comprising the capacity to allow:
(1) data writing from the top of the display panel down or from the bottom of the display panel up, and
(2) stopping data writing at end of any section and then starting writing from top or bottom of the display panel.

3. Method of claim 2,
said 3 sections comprising: section-1 in the top area of the display panel, section-2 in the middle area of the display panel and section-3 in the bottom area of the display panel;
said writing sequence comprising the following order of data writing to said 3 sections:
section-1, section-2, section-3, section-1, section-3, section-1,
section-3, section-2, section-1, section-3, section-1, section-3,
section-1, section-2, section-3, section-1, section-3, section-1.

4. Method of claim 1, said display panel or spatial light modulator comprising the capacity to allow data writing to any said section in random order.

5. Method of claim 4, said display panel or spatial light modulator further comprising the capacity to allow data writing to any row in each said section in random order.

6. Method of claim 5, said display panel or spatial light modulator further comprising the capacity to allow data writing to any word in each said row in random order.

7. Method of claim 1, said display plane comprising a screen, said screen displaying images from a spatial light modulator by a step of optical projection; said method further including a step of defining a number of color sub-panels on the display area of said spatial light modulator, each said color sub-panel being illuminated with a light of a different primary color.

8. Method of claim 7, each said section locating within the area of one of said color sub-panels.

9. Method of claim 8, said spatial light modulator comprising the capacity to allow data writing to any said section in random order.

10. Method of claim 8, said step of optical projection including the step of superimposing images from different said color sub-panels; said step of optical projection further including the steps of:
optically splitting the projected image into a first image and a second image, both being identical;
optically flipping said second image;
optically stitching the flipped second image together with said first image to form a new image frame of a different aspect ratio.

11. System for displaying volumetric 3D images comprising:
(1) an image projection unit;
(2) a translucent screen rotating around a common axis;
(3) an interfacing unit that relays the optical image projected from said image projection system onto the rotating screen while keeping the size, the orientation and the focus of the projected image invariant as the screen rotates;
(4) a beam splitting reflector and a set of mirrors rotating about said common axis in unison with the rotating screen, said beam splitting reflector splitting the projected optical image from said interfacing unit into a transmitting part and a reflecting part, said set of mirrors guiding said transmitting part to project to the left half part of the screen with respect to said common axis and guiding said reflecting part to project to the right half part of said screen from the opposite side of the screen, said transmitting part and reflecting part stitching together as a fill image frame.

12. A frame distribution structure for a volumetric 3D display, said volumetric 3D display comprising a rotating display plane, said display plane rotating around an axis and sweeping a display volume, said frame distribution structure dividing the display volume of the volumetric 3D display into a number of zones according to distance to said axis, zones closer to said axis being inner zones, zones farther away from said axis being outer zones, said inner zones comprising less frame divisions, said outer zones comprising more frame divisions, said spacing between adjacent frame divisions in said inner zones and in said outer zones being roughly equal.
